(19) United States
(12) Patent Application Publication
(10) Pub. No.: US 2007/0202862 A1
(43) Pub. Date: Aug. 30, 2007

(54) Method And Arrangement For Redirecting Data To be Transferred To A Mobile Station

(76) Inventor: Janne Mikkola, Aijala (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 10/590,841

(22) PCT Filed: Feb. 15, 2005
(86) PCT No.: PCT/FI05/50034

§ 371 Date: Aug. 24, 2006

(30) Foreign Application Priority Data
Feb. 25, 2004 (FI) 20045054

(51) Int. Cl. H04M 3/42

(52) U.S. Cl. 455/417; 455/428

(57) ABSTRACT

A method and arrangement are shown for diverting phone calls, especially in mobile networks. In the method for transmitting data from a receiving first mobile station, from which there is defined a call divert command to a second mobile station, to the second mobile station, there is identified the first mobile station from which data is being transmitted to the second mobile station, and in case the data transmitting mobile station is identified as the first mobile station, from which there was defined a call divert command to the second mobile station, the data is received in the second mobile station; or in case the data transmitting mobile station is identified as other than the first mobile station, from which there is defined a call divert command to the second mobile station, the data is transmitted to a predetermined receiver.

The invention relates to a method and arrangement for redirecting data to be transferred to a mobile station before receiving said data in the mobile station.

Mobile stations are attempted to be realized as very small and light-weight, and therefore they also become in a way fairly imperceptible. External features observed by sensual perception, such as ringing tones and color shells, may increase the attention factor of a mobile station, but for example the existence of a device carried in the pocket or in a bag is not immediately felt as weight. Therefore it must be separately checked that the device is carried along. A fairly unnoticeable, portable device is easily forgotten, because the missing of the device is not detected immediately. If a person's own mobile station has been left somewhere, it is often possible to loan a substitute. For instance many work communities have common phones that can be loaned. An employee may for example use the device of his own department, if he has left his personal device at home and needs a mobile phone during the day.

Typically short-time employees, such as rush-hour helps, are given a mobile phone to use for the duration of their employment. There also are work stations where exchangeable work phones are distributed to all current employees. The devices can be distributed for example every morning, or at the beginning of a certain project. The employer may update the device data, software and interfaces, so that the employee using the device obtains necessary information, such as instructions, reports, acknowledgements and requests by means of the device easily and rapidly, in real time. A typical example of work station devices are devices and networks that are particularly designed for authorities, which devices and networks have from the very beginning been developed exclusively for the use of authorities. For instance a police patrol may use any available device. Also in this case, they may use a borrowed device while the standard device of the work station in question is being maintained or updated.

When using mobile stations, phones or other borrowed devices that are common for several users, it is difficult to reach a certain person on the basis of a changing telephone number. In case a certain person among those who are using the work phone should be reached through said phone, it is necessary to know the number in which the user in question can be reached at the moment in question. Because exchangeable work phones are distributed according to the work stations, through a given phone there is reached the person in charge of a given work, job or task, but the reaching of a given person is not carried out in a straightforward manner. Moreover, the continuous exchanging of devices results in that different persons are reached at different times through a given number.

One of the problems is that in an exchangeable or borrowed mobile station, there is received a lot of connection requests, phone calls and messages, that are not meant for the phone's current user but for somebody else, perhaps the previous user of said phone, or the user before that. More problems are created in a situation where a person in charge of a given work station carries with him an exchangeable phone and diverts all calls from his stationary desk phone to the one that he is carrying with him. In case the person who made the call divert falls ill or goes on holidays, the next user of the mobile phone receives all calls diverted from the previous user's stationary phone to said mobile. The mobile phone cannot be used for canceling the call divert made from another device but affecting said mobile phone that is being used.

In some cases, the borrower or temporary user of the mobile phone can insert in the mobile device his own SIM (Subscriber Identity Module) card, whereby the device identifies the user and the user data. When a SIM card is inserted in the device, said device is identified as the device of said user, and it receives connection requests and data sent to the number defined by the SIM card of said user. However, it is not always possible to change the SIM card, because the SIM card is often in the user's own device that was accidentally left someplace else. In addition, there are different sizes of SIM cards, which means that the own card is not necessarily compatible with the borrowed device. There also are networks where SIM cards are not used at all, for instance fixed telephone networks, the CDMA (Code Division Multiple Access) system and TETRA (Trans European Trunked Radio).

The object of the invention is to alleviate the problems occurring in the prior art solutions. An object of the invention is to restrict the received data. Another object is a selective establishment of active connections between devices. Another object of the invention is the individualization, according to each current user, of the features of such mobile stations that have several users. Yet another object of the invention is a more versatile usability of mobile stations and their customization so as to be appropriate for each user.

These objects are achieved so that the device transmitting data is identified, and in case the transmitting device is identified as the mobile station from which there is defined a call divert to the receiving mobile station, the data is received; or if the device is identified as some other device than the one from where there was defined a call divert to the receiving mobile station, the data is transmitted to a predetermined receiving party.

The invention is characterized by what is set forth in the characterizing parts of the independent claims. Other embodiments of the invention are enlisted in the dependent claims.

In the embodiments of the invention, data is transmitted from a first mobile station to a second mobile station, when in the first mobile station, there is defined a call divert command, so that only the data transmitted from the first mobile station through the call divert command to the second mobile station is received in the second mobile station. Data transmitted to the second mobile station from elsewhere, from other devices, is redirected to a predetermined third receiving party. A system according to an embodiment of the invention includes means for identifying the device from which data is transmitted to the receiving second mobile station, and means for receiving data in the second mobile station, in case the data transmitting device is identified as that mobile station from which, according to a call divert command, data is transmitted to the receiving second mobile station, as well as means for transmitting data further to a predetermined third receiving party, in case the data transmitting device is identified as other than that mobile station from which, according to the call divert command, data is transmitted to the receiving second mobile station. The system according to the invention can be a mobile phone network, in which case the means according to the embodiment of the invention can be located in the mobile switching center or in the network terminals. According to another embodiment, the network arrangement of the system is a so-called direct mode network that transmits connections and data between its terminals, but does not include switching centers. In this other embodiment, the means according to the invention can be located in the network terminals or in the network gateway buses. According to an embodiment of the invention, the system includes means for identifying that previous device from which the data to be transmitted was last transmitted. According to an embodiment, the system includes means for redefining the receiver information when the previous transmitting device has been identified as that mobile station from which there is given a call divert command to the receiving device. In addition, the system includes means for transmitting data further to a redefined receiving party.

The device according to the embodiment of the invention is typically a mobile station, in which there is defined a call divert from another telephone number, so that the mobile station receives the requests for establishing a connection designated to said other telephone number. In the mobile station, there can respectively be defined a call divert command, so that also messages and corresponding data entities are forwarded to the receiver according to the call divert command. The mobile station according to the embodiment includes means for identifying that device in which the call divert command is defined, i.e. from which the data is transmitted. In addition, the mobile station includes means for redefining the receiver information of data, such as a request for establishing a connection, or of a message, and for transmitting the data further to a third, redefined party on the basis of the identified transmitter. The mobile station according to the embodiment includes information of the predefined third receiver and means for rerouting the data and/or for redirecting it to said third receiver.

A mobile switching center according to an embodiment of the invention for transmitting data, such as telephone calls or messages, as a response to detecting a call divert command, includes means for identifying the previous data transmitting device, and means for transmitting data to a second mobile station or a third receiving party on the basis of the identified transmitting device. The mobile switching center according to this embodiment looks up the necessary information in a home register where there is stored information, such as the types, information and identifiers of the devices, as well as the call, data or general divert commands and predetermined receiver information according to the embodiment of the invention for transmitting the data to a predetermined third party. The steps according to this embodiment for identifying the transmitting device and for possibly rerouting the data on the basis of the identified transmitting device are carried out in the network.

According to an embodiment of the invention, instead of a typical mobile network, there is used a so-called direct mode connection for transmitting various data, in which case there are not separate switching centers in the network between the devices. Now the steps according to this embodiment of the invention can be performed in the terminal device, or on the network gateway bus along which the data is transmitted, and where the means according to this embodiment can be arranged.

The means according to an embodiment of the invention for processing data as a response to detecting a divert command are software means. This embodiment of the invention includes software means for identifying the previous data transmitting device, and software means for defining the data receiver on the basis of the identified device.

A method according to an embodiment of the invention for transmitting data as a response to detecting a divert command includes steps where there is identified the device that transmitted the data, and on the basis of the identified transmitting device, the data is received or it is transmitted further to a predetermined third party. The data to be transmitted can be a request for establishing a speech connection, in which case, as a response to receiving the data, there is established the requested active speech connection between the original transmitter of the request and the receiver. The data to be transmitted can be a data entity, such as a message, that is transmitted to a receiver defined according to this embodiment. In this case, an active connection is not at all established between the devices.

By means of embodiments according to the invention, each current user of the device only receives data that is designated for him. All such data, for instance a request for establishing a speech connection, that is not transmitted in order to reach the current user, is identified on the basis of the identifier of that device that last transmitted the request for establishing a connection. Typically the device identifier is a telephone number, but devices can also be identified on the basis of some other identifier, such as the device ID identifier or the URI, Unify Resource Identifier.

According to the embodiments, data received from other devices than the one that defined the call divert command is forwarded to a given predetermined receiver, such as for instance to another device or to the voice mailbox of said receiving device. The receiver of other data than the data diverted according to a call divert command from a determined mobile station is selected according to the predetermined receiver information. Typically the receiver information includes at least the connection information of the receiving unit, i.e. a telephone number or other identifier, whereby the receiver is identified, and data can be transmitted to the receiving unit.

The arrangement according to the embodiment of the invention enables the receiving of only such calls, messages and other data that is meant for the current user. Such data that is not designated for the current user of the device is retransmitted elsewhere, and it does not disturb the user. According to the embodiments, only such diverted calls that were originally transmitted to the user's own telephone are received in the borrowed device. Consequently, the arrangement according to the invention is particularly useful in direct networks where SIM cards are not used, which means that the user cannot by any means be identified by the SIM card, irrespective of the device, as is the case in mobile networks. Said direct networks are for instance fixed telephone networks, TETRA and TDMA (time divided multiple access). Even in such networks where it is possible to identify the user and redirect the calls by means of SIM cards, there often are situations where the SIM card identification cannot for some reason be utilized. One common situation is that the user by accident leaves his mobile phone somewhere, in which case also the SIM card lies in the forgotten device. It also is possible that the user's SIM card must be maintained, repaired or updated, during which time the personal SIM card is not available. In addition, there are different types and sizes of SIM cards, which means that the user's SIM card is not necessarily compatible with the borrowed device.

The transmission of data according to an embodiment of the invention can also be realized between various networks of different types or with different frequencies. The restricting of received data according to an embodiment of the invention can also be utilized between different networks, where each network may have their own, individual devices. For example the frequencies used in the USA are different from those used in Europe, and therefore the devices to be used in the networks are different. In case the user does not have a so-called dual band device that can be used at both frequencies, he must change devices or borrow a device that works at the frequency of each place of residence. For example, a person traveling to the USA may divert the calls transmitted to his own device operating at the European frequencies by data divert to the number that he obtains in the USA. In the USA the user confirms in the device to which the data divert from his own device is directed that he wishes to receive only the data diverted from his own device, and he can for example forward all calls coming from elsewhere to the mobile switching center and all messages coming from elsewhere to a given other number. Call diverts according to the embodiments of to the invention also help people working in the switching centers of companies, because they need not continuously manually update the users of common telephone devices. The call diverts defined according to the embodiments of the invention enable an automatic transmission of requests for establishing a connection to a predetermined receiving unit.

Let us now observe some embodiments of the invention in more detail with reference to the appended drawings, where

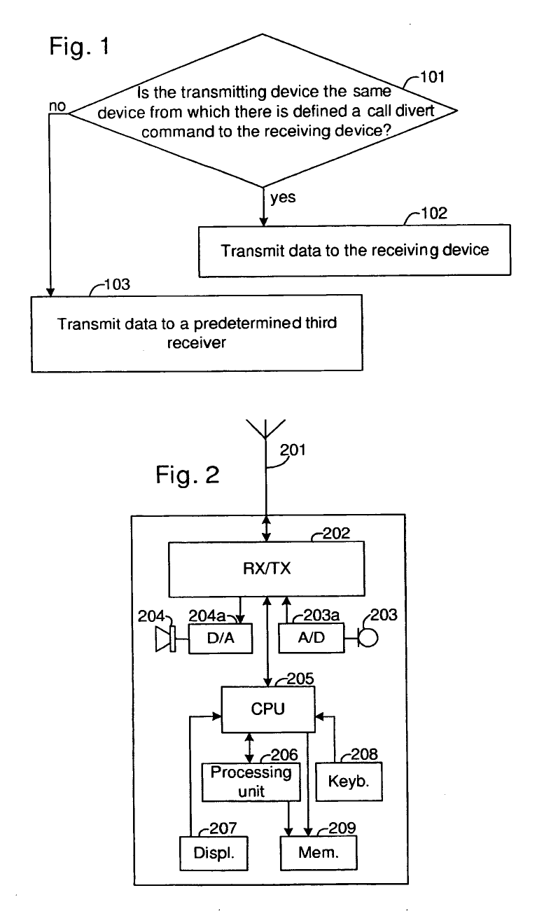

FIG. 1 illustrates a method according to an embodiment of the invention for transmitting data,

FIG. 2 illustrates a device according to an embodiment of the invention for transmitting data,

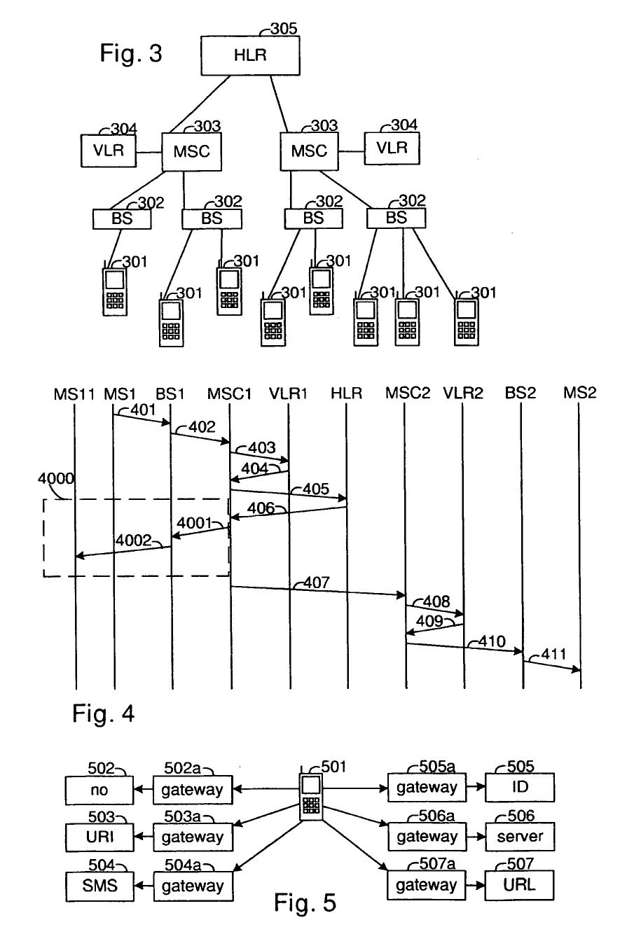

FIG. 3 illustrates a network according to an embodiment of the invention for transmitting data,

FIG. 4 illustrates the transmission of messages according to an embodiment of the invention for transmitting data, and

FIG. 5 illustrates an arrangement according to an embodiment of the invention for transmitting data.

FIG. 1 illustrates a method according to an embodiment of the invention, where in step 101, there is identified the device from which data is transmitted. According to an embodiment of the invention, there is particularly identified the latest device from where data was last transmitted. Thus it is possible to identify, instead of the original transmitter of the data, the device from which data is diverted by a call divert command to the next device. Typically the transmitting device identifier, such as for instance a telephone number, is transmitted along with the data, such as for example a message or a request for establishing a connection. Generally both the previous transmitting device and the original transmitter of the data can be tracked down on the basis of the data to be transmitted. In particular in step 101, it is checked whether the previous data transmitting device is the device from which there is defined a call divert command, according to which data is transmitted further to the second receiving device.

In case in step 101 it is detected that data is being transmitted to the receiving device from that device from which there is defined a call divert command for transmitting data to said receiving device, data is transmitted to this the receiving device in step 102. The data to be transmitted can be a data entity that is transmitted to the receiver as a whole. These data entities are for instance messages, such as voice messages, text messages or multimedia messages. The directed to the receiver by means of a call divert. In that case between the receiver and the original transmitter of the request for establishing a speech connection, there is established the requested speech connection, where both parties actively participate. The data can thus be sound, voice, text, image, video, moving image, multimedia or any other type of data transmitted between said devices.

If in step 101 there is detected that data is transmitted to the receiver from some other device than the one from which there is defined a call divert command, operations proceed to step 103. In step 103, a certain predetermined third receiving party is changed as the receiver of the data. The steps according to this embodiment can be realized by a terminal device, in which case in the terminal device there is stored information of a third receiver. The receiving device can be for example a mobile station operated under a mobile network, or a direct connection network terminal. According to an embodiment, the identification of the transmitting device according to step 101 and the possible retransmission of the data according to step 103 are performed by said receiving device.

The steps according to the embodiment can also be performed in the network, in which case the information of the third receiver is stored in a network unit, or for instance in the mobile network home register. Receivers and transmitters are typically identified by a certain identifier, such as a telephone number or other such address or location information to which data can be transmitted. In addition to the connection information of the receiving unit, the receiver information may also contain for example information of the type of the receiving unit, the method of transmission to said device, the format requested by said device, the message or transmission protocol, etc. According to another embodiment, the data transmitter is defined according to step 101 in the mobile network switching center. According to said other embodiment, the rerouting and retransmission of data to a third receiver according to step 103, or the transmission of data to said receiver according to step 102 is performed in the mobile network.

FIG. 2 illustrates an example of a terminal device according to an embodiment of the invention. The terminal device illustrated in FIG. 2 is for example a mobile station operated in a mobile network. The device described as an example of this embodiment is a wireless device that is in connection with other devices by intermediation of a network. According to some embodiments of the invention, the device can also be a permanently fixed device or a device that is operated under some other network.

The device of FIG. 2 has an antenna 201 that transmits and receives data, typically in radio frequency waves. The data to be transmitted and received proceeds through the transmission and reception unit 202 of the device. The transmission and reception unit 202 includes a transmission branch that converts the digital data to be transmitted in a form where it can be transmitted, via the antenna 201, to the network. In addition, the transmission and reception unit 202 includes a reception branch that converts the data received from the network to digital form, where the device can process it. For instance, when in the device there is formed a speech connection to another device, the voice data coming from the network is received via the antenna 201 in the reception branch of the transmission and reception unit 202, where the received radio waves are typically demodulated, downconverted, channel decoded and speech decoded. Thereafter the digital data is converted to analog by a digital/analog converter 204a, and the produced analog data is transmitted to a loudspeaker 204 that reproduces the received voice data. Respectively, when the user speaks in a microphone 203, the voice data is converted from analog to digital by an analog/digital converter 203a and conducted to the transmission branch of the transmission and reception unit 202, where the digital data is speech encoded, channel encoded, modulated and upconverted prior to transmitting the radio waves through the antenna 201 to the network.

The center unit 205 of the device supervises the device functions and controls other blocks and controllers. In the device, there is illustrated a keyboard 208 as an example of the input means, and a display 207 for representing the data to the user. A device according to an embodiment of the invention comprises a processing unit 206 whereby the received requests for establishing a connection are processed. According to this embodiment of the invention, the data received through the antenna 201 is transmitted from the transmission and reception unit 202 to the center unit 205, which transmits it further to the processing unit 206. The processing unit 206 identifies the device that last transmitted a request for establishing a connection. A mobile station according to this embodiment includes means for redefining the data receiver on the basis of the identifier of the identified previous transmitting device. In particular, a mobile station according to an embodiment includes means for identifying the telephone number that transmitted the request for establishing a connection as the telephone number from which a call divert is defined, or for identifying the message transmitting device as that mobile station from which data divert is defined.

A mobile station according to this embodiment includes means for redefining the receiver information contained in the received request for establishing a connection or data entity according to predetermined receiver information. The processing unit 206 can have a specific memory unit, or for instance a given area in the memory unit 209 of the device can be allocated for its use. Typically in the memory space used by the processing unit 206, there is stored information and instructions for processing data. Typically the predetermined information and instructions contain the information of a given transmitter to be identified, and the information of an alternative other receiver. In case the transmitting device is the one from which there is defined for example a call divert command to said receiving device, the request for establishing a connection is activated normally by said receiving device, so that the request for establishing a connection is received, and as a consequence, an active connection is established between the receiver and the original transmitter of the request for establishing a connection. In another case, in case the transmitting device is some other device, the request for establishing a connection is directed for instance to a given third device or for example to a mailbox of said device, said mailbox receiving messages or other data according to predetermined instructions. According to an embodiment it can be defined that requests for establishing a speech connection are directed to a given telephone number, and data entities, such as messages, are directed to a given other address. In this case also the type of the data to be received is identified before its rerouting and further transmission.

A mobile station according to an embodiment is provided with means for rerouting different kinds of data to a predetermined receiving party on the basis of the previous identified telephone number transmitting data. Said rerouting operations can be realized so that there is defined and saved a routing instruction, i.e. for example a telephone number, network address or an ID identifier, to which the data is directed. In addition, the instructions typically include information of the transmission protocol, transmission method, the receiving unit type or data conversion to a form that is suitable for the receiver. The device illustrated in FIG. 2 includes means for changing the receiver information of the request for establishing a connection as a response to identifying the device that transmitted the request as another device than that from which a call divert command is defined.

FIG. 3 illustrates a mobile network where an arrangement according to an embodiment of the invention can be realized. The network can be for example a GSM network (Global System for Mobile Communications) or some other cellular radio network having different frequency. The mobile network includes several mobile stations 301. Each mobile station operates under a given base station 302. Now the mobile station is located within the range covered by said base station, i.e. not further from said base station than said coverage. Certain base stations 302 belong under a given mobile switching center 303. Each mobile switching center 303 has its own visitor register 304 that maintains information of the locations of single devices 301 within the area of the base stations 302 that belong under said mobile switching center 303. The visitor register 304 may iterate that base station, in the coverage of which a given device 301 is located at the moment. The mobile switching centers 303 are interconnected, and the mobile switching centers 303 in a given area keep a common home register 305. The home register 305 includes information as to which mobile switching center 303 controls which single device 301 in said network.

According to an embodiment of the invention, the mobile switching center 303 looks up in the network home register 305 information in order to identify the previous transmitter of the data transmitted between the mobile stations, and in order to define the receiver according to the identified transmitter. The home register 305 registers and updates information. In the home register 305, there are also updated the divert commands according to the embodiment of the invention. The home register 305 includes information for rerouting data to be transmitted to a given device, for example for redirecting other data than the data diverted by the divert command to the defined receiving party. According to an embodiment, the home register 305 updates the data directed to a given mobile station on the basis of the previous transmitter of said data, so that all other data except for the data coming from the mobile station that made the call divert is conducted to a predetermined third party. Data can also be directed, according to the identified data type, to various different receiving parties. According to an embodiment, the home register 305 updates a new receiver for said identified data for example by changing the receiver information as regards the request for establishing a connection or the data entity to be transmitted. Thus the data is directed to a new receiver updated by the home register 305, which new receiver can be another device in the same network, or a device in some other network, to which device the data can be transmitted from the current network.

According to an embodiment, the mobile switching center 303 includes means for routing the request for establishing a connection to a given receiving location by redefining the receiver information of the request for establishing a connection, on the basis of the identified device transmitting the request for establishing a connection. In this embodiment, the mobile switching center 303 looks up the information, such as the processing instructions associated to a given telephone number, in the home register 305 and processes the request for establishing a connection according to said embodiment, on the basis of the looked-up information saved and updated in the home register 305. The mobile switching center 303 redefines the receiver information on the basis of the processing information looked up in the home register 305 and routes the request for establishing a connection to a new receiving device other than the original device, according to the processing instructions. The processing instructions may also include information for converting the data received from a given device to another form, for example to text form or hypertext form data, in which case the information can be transmitted for instance to a text message center or to an email server.

FIG. 4 illustrates the passage of messages in a mobile network. The example here is a situation where the mobile station MS1 wishes to establish a speech connection with the mobile station MS2. First the request for establishing a connection, transmitted by the mobile station MS1, is transmitted 401 to that base station BS1 under which the mobile station MS1 is currently located. The base station BS1 transmits 402 a request for establishing a connection further to that mobile switching center MSC1 under which the base station BS1 is located. The mobile switching center MSC1 makes an inquiry 403 in the visitor register VLR1 in order to find out whether the receiving device MS2 is located in the area of said mobile switching center MSC1. In case the receiving device MS2 is located in the area of the same mobile switching center MSC1 as the device MS1 transmitting the request for establishing a connection, the visitor register VLR1 transmits the data 404 to the mobile switching center MSC1. In case in the receiving device MS2 there is, according to an embodiment of the invention, defined a call divert, the visitor register VLR1 can send to the mobile switching center MSC1 information to that effect, or instructions to make an inquiry in the home register HLR containing said information. In the latter case it suffices that the visitor register VLR1 transmits 404 to the mobile switching center MSC1 information that the receiving mobile station MS2 is not located in the area of said mobile switching center MSC1, because thereafter the mobile switching center MSC1 automatically transmits the inquiry of the location of the receiver MS2 to the home register HLR.

In the embodiment of FIG. 4, the mobile switching center MSC1 receivers from the visitor register VLR1 a notice 404 that the receiving device MS2 is not in the area of said mobile switching center MSC1. Next the mobile switching center MSC1 transmits 405 an inquiry of the location of the receiver MS2 to the home register HLR that contains information of the current locations of all single mobile stations under its control. In the home register HLR, there also is registered information of a call divert according to this embodiment of the invention, which call divert is made for said receiver MS2. From a given other number or device, there is defined a call divert to the device MS2. According to an embodiment of the invention, when the call divert is defined, the user of the device MS2 has typically also confirmed that he wishes to receive, according to the embodiment of the invention, for example only those calls that are diverted to the device MS2 through the call divert operation. In addition, the user may for instance confirm that other calls than those coming through call divert to the device MS2 are directed to a given third device MS11, and they are not at all received in the device MS2. Typically the user confirms these operations concerning the device that he is using.

The home register HLR includes information as regards the receivers of the requests for establishing connections. The home register HLR also includes information for identifying the transmitter. In case the identified transmitter is a device whose requests for establishing a connection the receiving device MS2 has confirmed to receive, the home register HLR transmits 406 the information to the mobile switching center MSC1. The mobile switching center MSC1 receives a notice that the searched receiving device MS2 is under control of the mobile switching center MSC2. The mobile switching center MSC1 transmits 407 a request for establishing a connection to the mobile switching center MSC2. The mobile switching center MSC2 receives the request for establishing a connection and transmits 408 to the visitor register VLR2 an inquiry to find out under which base station controlled by the VLR2 said receiver MS2 is located. As a response, the visitor register VLR2 transmits 409 to the mobile switching center MSC2 a notice that the device MS2 is located in the coverage range of the base station BS2. The mobile switching center MSC2 transmits 410 a request for establishing a connection, on the basis of the information received from its visitor register VLR2, to the base station BS2, from where the request for establishing a connection is transmitted further 411 to the receiving device MS2.

According to an embodiment, when the mobile switching center MSC1 has in step 405 transmitted an inquiry to the home register HLR, the home register HLR identifies the number as one that has been redirected to another number by the receiver MS2 indicated in the request for establishing a connection. Now the home register HLR can transmit a notice to that effect to the mobile switching center MSC1. According to an embodiment, the home register HLR includes means and information for changing the receiver information contained in the request for establishing a connection. The home register HLR changes the receiver information and transmits both the redefined receiver information and information of the current location of the defined new receiver to the mobile switching center MSC1. A rerouting operation according to an embodiment is illustrated in FIG. 4, in the box 4000 marked by dotted lines. The mobile switching center MSC1 gets a notice of the new receiver, or typically it gets the modified request for establishing a connection, where the receiver information is changed. In this example, the new receiver is defined as the device MS11, which is located under control of the mobile switching center MSC1 and its base station BS1. The mobile switching center MSC1 transmits 4001 a request for establishing a connection to the base station BS1, which transmits it further 4002 to the redefined receiving device MS11.

In mobile networks, there can respectively also be processed data entities passing between devices, for example data packets, text messages (SMS, Short Message Service), MMS messages (Multimedia Messaging Service) and other data to be transmitted. Data entities are typically transmitted as a given whole, and there is no need to establish an active connection between the transmitter and the receiver. Mobile network messages pass through the message center. According to an embodiment, message divert commands, new receivers, alternative receivers and the information requested for retransmitting messages is registered in the message center.

According to an alternative embodiment, the processing of requests for establishing a connection is carried out in the network terminal device. According to this embodiment, the messages proceed in the network in a similar fashion as in the above description. A difference with what is set forth above is that the requests for establishing a connection do not obtain a new receiver in the network, for instance in the home register, visitor register or mobile switching center, as in FIG. 4, but according to this embodiment, the requests for establishing a connection are always transmitted to that receiver that was originally defined in the request for establishing a connection. The receiving device processes the request for establishing a connection to the device according to predetermined processing instructions. In case a given request for establishing a connection transmitted from a given number is not wished to be received in said device, the request for establishing a connection obtains a new receiver, and the request for establishing a connection is transmitted further to this new receiver, and it is not activated in the device. In this embodiment, the new receiver is typically located in the same network as the device processing and rerouting the request for establishing a connection. The new receiver may also be located in the area of a different network than the device processing the request for establishing a connection. The request for establishing a connection is transmitted, in a way known as such in the network, on the basis of the new receiver information, and in this embodiment the network does not necessarily perform any steps according to the embodiments of the invention, or contain any means required by the embodiments of the invention. Now the operation according to the embodiments of the invention is not restricted in a certain network only, but it can be carried out irrespective of the network. In that case the embodiments can also be applied in networks that do not have separate switching centers, or between different types of networks.

Some embodiments of the invention can be applied in the so-called direct mode that does not have any separate network components, but the devices are directly connected through the intermediation of a given bus. The operators' commands and various messages proceed through said buses, so-called gateway buses. In this kind of direct mode calls, it is possible to preform operations according to the embodiment of the invention in the gateway bus. In the gateway bus, data proceeding from a device to another can, for instance on the basis of an identifier, be detected to be processed according to the invention. The data can be processed when it is detected that the user of the device that is defined as its receiver has confirmed to receive only data that is coming (diverted) from a certain other device. According to an embodiment, the bus has means for processing and rerouting the request for establishing a speech connection on the basis of predetermined processing instructions. Typically on the bus there can respectively be processed also data entities, such as messages. According to an embodiment, the devices can be directly interconnected by means of a so-called User-to-User-Signaling (UUS) technique. In that case the data receiver can transmit to the original transmitter for example a notice that the transmitted data is retransmitted to the person he wishes to contact, to another number or address.

According to an embodiment of the invention, the means for identifying the previous, data transmitting device and means for processing the data on the basis of the identified transmitting device are software means. According to an embodiment of the invention, the software component may be located in a terminal device, in which case the terminal device center unit controls its operation, and the software component can be a software running the steps according to the embodiment. According to another embodiment of the invention, the software component is located in the network. In that case the software and the possible running components must be adapted in said network. A software operated for instance in a mobile network, in a message center, in a home register or in a mobile switching center, and the means and components required by said software, differ from the software components and programs used in other networks or in the gateway buses of various different networks.

FIG. 5 illustrates, by way of example, receiving units to which the data to be redirected according to an embodiment of the invention can be transmitted. In this embodiment, there are illustrated some devices, addresses and identifiers that can be changed, i.e. redefined to replace the identifier of the identified transmitting device, and on the basis of these, the data to be transmitted is then directed to the redefined receiver other than the original one. The embodiment shown by way of example in FIG. 5 illustrates a mobile station 501, from which data is redirected according to an embodiment of the invention. The component or means for retransmitting data can be any device within the scope of the invention, i.e. a terminal device, a network unit, a gateway bus unit, a software component or the like that is capable of performing the rerouting according to the embodiments that must possibly be carried out on the basis of the identified transmitter, as well as the appropriate retransmission.

In FIG. 5, as a piece of new receiver information there is defined the telephone number 502. The data to be transmitted to the telephone number 502 proceeds through some gateway bus 502a, typically for instance a telephone network. The defined telephone number 502 can be for example the number of a answering service realized as network service, in which case the request for establishing a connection is transmitted to the defined answering service. If the telephone number 502 is a device identifying a mobile station, said device can receive, apart from requests for establishing a speech connection, also for example message-form data. The data can be directed to an address or location URI (Uniform Resource Identifier) defined through a given gateway bus 503a. In this embodiment, data can for example be transmitted to a given database in the network as a notice that said speech connection has been attempted to be established. The data can be converted for example to text-form in the step where the identifier 503 is defined as the data receiver, or in the step where the data is received in transmission form in the defined new location or address 503. According to an embodiment, the request for establishing a connection is transmitted along the network bus 504a to the message center 504. In this embodiment, the receiver may remain as the original one, and for example the request for establishing a connection can be made into a text-form message that is transmitted to said original receiver. According to an embodiment, the request for establishing a connection can be transmitted as a MMS (Multimedia Messaging Service) form message, in which case there can be transmitted a sound cut in addition or instead of a text-form message. The data proceeding through the message center can also be diverted according to the invention, by redefining the receiver according to the information registered in the message center.

According to an embodiment, data can be directed, through the gateway bus 505a, to a given device on the basis of its ID identifier 505. The device can be for example a log information collecting machine to which the data is transmitted to be saved and registered for a possible later survey. The device can also be a given network terminal in which certain diverted requests for establishing a connection in the office are directed, or any device that is identified on the basis of its ID identifier and can receive data to be transmitted between mobile stations. According to an embodiment, the data is directed, through a gateway bus 506a, to the server 506. The server can be for example the server of a local network. For instance, a given server 506 of the work site can further process the received requests for establishing a connection, and for instance save them in a defined location and/or send further information of them through email. FIG. 5 shows how data is transmitted through a gateway bus 507a to a given URL (Uniform Resource Locator) address.

1. A method for transmitting data from a receiving first mobile station, from which there is defined a call divert command to a second mobile station, to said second mobile station, characterized in comprising
identifying the first mobile station for said transmitting data to the second mobile station, and
in case the data transmitting mobile station is identified as the first mobile station, from which there is defined a call divert command to the second mobile station, receiving the data in the second mobile station, or
in case the data transmitting mobile station is identified as other than the first mobile station, from which there is defined a call divert command to the second mobile station, transmitting the data to a predetermined receiver.

2. A method according to claim 1, characterized in that the first mobile station, from which data is being transmitted to the second mobile station, is identified by a network device before transmitting the data to the second mobile station, and the second mobile station is selected according to the identified transmitting mobile station by said network device.

3. A method according to claim 1, characterized in that the first mobile station, from which data is being transmitted to the second mobile station, is identified in the second mobile station before activating the data in the second mobile station, and according to the identified transmitter, the data is received in said second mobile station, or it is transmitted further to a predetermined third receiver.

4. A system for transmitting data from a first mobile station to a second mobile station as a response to a call divert command in the first mobile station, characterized in that the system comprises:
an identifying element for identifying a data transmitting device from which data is being transmitted to the receiving second mobile station,
a receiving element for receiving data in the second mobile station, in case the data transmitting device is identified as that mobile station, from which data, according to the call divert command, is transmitted to the receiving second mobile station, and
a further transmitting element for transmitting data further to a predetermined third receiver, in case the data transmitting device is identified as other than that mobile station from which data, according to the call divert command, is transmitted to the receiving second mobile station.

5. A system according to claim 4, wherein it includes an identifying element for identifying that previous device from which the data was last transmitted.

6. A system according to claim 4, wherein it includes a redefining element for redefining receiver information of the transmitted data based on predefined receiver information, as a response to identifying the data transmitting device as other than that mobile station, from which data, according to the call divert command, is transmitted to the receiving second mobile station.

7. A system according to claim 4, wherein it includes a redefining element for redefining the data receiver information based on data type, according to predetermined instructions, as a response to identifying the data transmitting device as other than that mobile station from which data, according to the call divert command, is transmitted to the receiving second mobile station.

8. A system according to claim 4, wherein the system elements are software elements.

9. A system according to claim 4, wherein the system is a mobile communication network, and that the elements are located in a message center or a mobile switching center, or both.

10. A system according to claim 4, wherein the system is a network, and the elements are located in a network gateway bus.

11. A system according to claim 4, wherein the system is a network, and that the elements are located in a network terminal device.

12. A mobile station, in which there is defined a call divert command from another mobile station, so that the mobile station receives data designated to said second mobile station, characterized in that the mobile station includes
an identifying element for identifying a data transmitting device, from which data is being transmitted to the mobile station,
a receiving element for receiving the data in the mobile station, in case the data transmitting device is identified as that second mobile station, from which data, according to the call divert command, is transmitted to the mobile station, and
a transmitting element for transmitting data further to a predetermined third receiving party, in case the data transmitting device is identified as other than that second mobile station, from which data, according to the call divert command, is transmitted to the mobile station.

13. A mobile station according to claim 12, wherein a mobile station that receives a request for establishing a connection includes an identifying element for identifying a telephone number transmitting the request for establishing a connection as that telephone number from which the call divert is defined.

14. A mobile station according to claim 12, wherein it includes an establishing element for establishing a connection between the mobile station transmitting an original request for establishing a connection and a mobile station receiving the request for establishing a connection.

15. A mobile station according to claim 12, wherein the mobile station includes a rerouting element for rerouting a request for establishing a connection based on an identified telephone number transmitting the request for establishing a connection.

16. A mobile station according to claim 12, wherein it includes a receiving element for receiving a message in a mobile station, as a response to identifying a previous data transmitting device as that second mobile station from which data, according to the call divert command, is transmitted to the mobile station.

17. A mobile station according to claim 12, wherein the mobile station includes a redefining element for redefining the receiver of a message and a transmitting element for transmitting the message further to a redefined receiver as a response to identifying a previous data transmitting device as other than that second mobile station from which data, according to the call divert command, is transmitted to the mobile station.

18. Mobile switching center for transmitting data as a response to detecting a call divert command, characterized in that the mobile switching center includes
an identifying element for identifying a data transmitting device from which data is transmitted to receiving mobile station,
a transmitting element for transmitting data to the mobile station, in case the data transmitting device is identified as a mobile station from which data, according to the call divert command, is transmitted to the receiving mobile station, and
a transmitting element for transmitting data to a predetermined other receiver, in case the data transmitting device is identified as other than that mobile station from which data, according to the call divert command, is transmitted to the receiving mobile station.

19. A mobile switching center according to claim 18, wherein the center is able to look up in a network home register information for identifying a previous transmitter of the data and for defining a receiver according to an identified transmitter.

20. A mobile switching center according to claim 18, wherein the center includes a redefining element for redefining data receiver information as a response to identifying the data transmitting device as other than that mobile station from which data, according to the call divert command, is transmitted to the receiving mobile station, and a rerouting element for rerouting transmitted data to a redefined receiver.

21. A mobile switching center according to claim 18, wherein it includes an establishing element for establishing an active connection between the original data transmitter and the data receiver.

22. A mobile switching center according to claim 18, wherein the center includes a transmitting element for transmitting a given data entity to the receiver.

23. Software element for processing data for transmission as a response to detecting a call divert command, comprising
software element for identifying a data transmitting device,
software element for transmitting data to a receiver according to the call divert command, in case the data transmitting device is identified as a mobile station from which data, according to the call divert command, is transmitted to the receiver, and
a transmitting element for transmitting data to a predetermined other receiver, in case the data transmitting device is identified as other than that mobile station from which data, according to the call divert command, is transmitted to the receiver.

24. Software element according to claim 23, located in a network unit.

25. Software element according to claim 23, located in a network gateway bus.

26. Software element according to claim 23, located in a terminal device.
